(19) United States
(12) Patent Application Publication
(10) Pub. No.: US 2019/0258183 A1
(43) Pub. Date: Aug. 22, 2019

(54) DIGITAL PRINTED WEBS AND SHEETS WITH SEMI-INTERPENETRATING POLYMER PRIMER LAYERS

(71) Applicant: Daybreak Technologies, Inc., Browns Summit, NC (US)

(72) Inventor: Timothy J. Leeper, Greensboro, NC (US)

(73) Assignee: Daybreak Technologies, Inc., Browns Summit, NC (US)

(21) Appl. No.: 16/401,243

(22) Filed: May 2, 2019

Related U.S. Application Data
(63) Continuation of application No. PCT/US2017/056930, filed on Oct. 17, 2017.
(60) Provisional application No. 62/417,693, filed on Nov. 4, 2016.

(51) Int. Cl. G03G 7/00; B41M 5/00; B41M 5/20

(52) U.S. Cl. CPC G03G 7/0046; B41M 5/0011; B41M 5/0058; B41M 5/0023; B41M 5/20; B41M 2205/40; B41M 2205/12; B41M 5/0064

(57) ABSTRACT

A digital printing process that applies a liquid radiation curable primer containing 20 to 80% of at least one acrylate functional monomer and 20 to 60% of at least one thermoplastic polyurethane polymer onto a surface of a flat web or sheet substrate; cures the primer by UV or EB irradiation to give a dry, tack-free surface; and then uses a digital printing press that uses a liquid-toner-based electrographic imaging process with a press blanket to transfer a printed image from the press blanket to the cured-primer coated substrate. The resulting printed web or sheet may have a dry, tack-free semi-interpenetrating polymer network layer adjacent the printed image.

### CROSS REFERENCE TO RELATED APPLICATIONS

This application is a continuation of International Patent Application No. PCT/US2017/056930, filed Oct. 17, 2017 which claims the benefit of U.S. Provisional Application No. 62/417,693 filed Nov. 4, 2016, each of which is hereby incorporated by reference.

### BACKGROUND OF INVENTION

Digital printing has become widespread. This includes inkjet and electrographic printing processes. Electrographic printing can be further subdivided into processes using liquid and dry toner based ink systems. Liquid toner based digital printing offers high print quality with relatively thin ink layers. A well-established liquid toner printing system is available from Hewlett-Packard under the trade name HP Indigo. The HP Indigo printing process involves the formation of images on a photosensitive drum. The image is then transferred to an intermediated blanket before subsequent transfer to the desired substrate. HP Indigo systems are available for printing on substrates that are in the form of sheets or webs

One disadvantage of the HP Indigo printing process is that the image does not transfer or anchor well to many substrates. A number of primers have been developed to enhance the transfer and subsequent adhesion of HP Indigo inks to the substrates. The available primers are either water based or solvent based coatings. Typical water based primers are described in U.S. Pat. No. 7,470,736, entitled “Primer coating for enhancing adhesion of liquid toner to polymeric substrates.” Water or solvent based primers are applied to the substrates with various types of roll coating equipment which may be in-line or off-line with the HP Indigo printing. The water or solvent is removed using a thermal dryer leaving a thin polymer layer on the substrate.

Water and solvent based primers can be challenging to run. Digital printing provides the desired graphics on demand; therefore, the press is often used for short runs with frequent starts and stops. Under these conditions the primer can begin to dry on the coater rolls. Also the coater must be thoroughly cleaned immediately following shut-down to prevent problems caused by primer drying on the coating equipment. Also a significant amount of energy is need to evaporate the water and solvent. Solvent based primers also cause issues with air pollution and flammability hazards which are costly to control. An issue with water based primers is the water resistance of the resulting printed materials. This can be a significant issue for printed products where the integrity of the graphics need to be maintained in a moist environment.

It would be very desirable to have 100% solids ultraviolet (UV) or electron beam (EB) curable primers that are essentially free of solvent or water. UV and EB curable coatings each can be a stable liquid before curing thus eliminating issues with drying on coater equipment. UV and EB each can provide very rapid curing with low energy usage. UV and EB curable coatings each can also eliminate issues with solvent emissions and flammability hazards.

European Patent EP 2 426 176 discloses a 100% solids energy curable HP Indigo primer which can be cured by UV or EB irradiation. This reference is very specific to primer formulations with both polyester acrylate and acrylated amine components. The examples in EP 2 426 176 show ink adhesion to primer of only 70 to 80%. A higher ink adhesion percentage is desirable thus indicating a need for improved primer performance.

### DESCRIPTION OF INVENTION

One embodiment of this invention is a liquid toner based electrographic printing process for affixing an ink image to web or sheet substrate that has a thin layer of UV/EB cured primer. Another embodiment is web or sheet substrate with a thin layer of UV/EB cured semi-interpenetrating polymer primer and an image layer of dried liquid electrographic ink.

Acrylate functional monomers are desirable for use in the primer's compositions due to their ability to cure quickly under UV and EB exposure conditions. The monomers used in the primers may have from one up to about six acrylate end groups. Monomers with two or more functional groups provide crosslinking upon curing. Some degree of crosslinking is desirable so that the cured primer has some good mechanical and thermal resistance properties. Excessive crosslinking will produce brittle coatings and have a negative effect on the primer to be receptive to subsequent digital printing. The properties can be tailored by the monomer selection and may include mixtures with more than one monomer. Acrylate functional monomers are commercially available from several different suppliers including but not limited to Sartomer, Allnex, Miwon, IGM Resins, and Eternal. Examples of monofunctional monomers include but are not limited to isobornyl acrylate (IBOA), phenoxyethyl acrylate (PEA), 2-(2-ethoxyethoxy)ethyl acrylate (EOEOEA), tetrahydrofurfural acrylate (THFA), cyclic trimethylol propane formal acrylate (CTFA), octyl decyl acrylate (ODA), isodecyl acrylate (IDA), lauryl acrylate (LA), 2-ethyl hexyl acrylate, and ethoxylated nonylphenol acrylate. Examples of difunctional monomers include but are not limited to: hexane diol diacrylate (HDDA), tripropylene glycol diacrylate (TPGDA), propoxylated neopenylgyycol diacrylate (NPGPODA), polyethylene glycol diacrylate (PEGDA), ethoxylated bisphenol-A diacrylate. Examples of trifunctional and higher acrylate monomers include: trimethylol propane triacrylate (TMPTA), ehoxylated trimethylol propane triacrylate, propoxylated glyceryl triacryate (GPTA), and petaerythritol tetraacrylate (PETA). Methacrylate monomers could also be used in relatively low amounts but are not generally preferred because they cure slower compared to acrylates. Another class of monomer which is useful in the primers are amine acrylates. These materials are formed by the Michael addition of secondary amine with multi-functional acrylates. The often contain both acrylate and tertiary amine functional groups. Amine acrylates can serve to increase cure speed, reduce oxygen inhibition, and improve surface cure. Examples of commercial amine acrylates include but are not limited to Ebecryl 7100, and P115 from Allnex, and Photomer 4771 and 5006 from IGM Resins. Another criteria for monomer selection is the ability to solubilize the thermoplastic polymer that is also present in the primer composition.

In addition to acrylate functional monomers the primers may include acrylate functional oligomers. Oligomers are higher molecular weight compared to monomers. Oligomers may have an average of one, two, or three acrylate groups per oligomer. Higher functionality up to about about 5 of 6 are also possible. Oligomer backbones may include epoxies, urethanes, polyesters, polyethers, and acrylics. Oligomers are commercially available from the same suppliers that provide monomers.

Thermoplastic polymers have little or no acrylate functional groups. They also have little or no other reactive function groups that would cause them to crosslink. Thermoplastic polymers may be linear or branched and are often referred to as resins. For the purpose of this discussion the term polymer and resins may be used interchangeably. The average molecular weight of the thermoplastic polymers is preferably between about 1000 and 10000. Thermoplastic polymers are incorporated in the primer by dissolving in the acrylate monomers. Fine powered thermoplastic polymers could also be potentially dispersed in the monomers. Upon curing, the monomer is expected to crosslink and form a network around the thermoplastic. The resulting materials may be characterized as a semi-interpenetrating polymer network (semi-IPN). Some minor crosslinking or grafting may occur between the thermoplastic polymer and monomer upon curing; however, the material will still be predominantly a semi-IPN. The primer may still function well even if the minor crosslinking or grafting occurs. The network that makes up the cured primer may be relatively homogeneous or may contain domains where there is some separation of the thermoplastic polymer from the network which is formed upon polymerization of the monomer.

Examples of thermoplastic polymers that may be this invention include hydrocarbon resins, chlorinated polyolefins, acrylics, polyamides, cellulose esters, and thermoplastic polyurethane resins (TPUs). Preferred polymers for this invention are TPUs. TPUs are linear polymers which can be processed by melting or dissolving in a suitable solvent or monomer. In contrast to urethane (meth)acrylate oligomers which are commonly used in UV/EB curable composition, TPUs do not have reactive acrylate or methacrylate functional groups. TPUs are produced by the reaction of diisocyantes with short or long chain diols. The diols may be polyethers or polyesters. TPUs are commercially available from multiple suppliers including but not limited to EPAFLEX (Epamould, Epaline, Epacol, Pakoflex trade names), BASF (Elastollan), Lubrizol (Pearlthane, Estane, Pellethane, Pearlstick, Pearlbond, trade names), Huntsman (Irogran, Avalon), COIM (Laripur), Greco (Isothane).

TPUs may be characterized by physical properties including the Shore hardness, glass transition temperature, and melting point of the polymer. The preferred melting point range for TPUs used in this invention is about 50 to 150 degrees C. Another preferred criterion for the section on TPUs for this invention is solubility acrylate functional monomers.

A free-radical photoinitiator is included in the primer formulation to allow UV curing. Examples of suitable photoinitiators include 2-benzyl-2-(dimethylamino)-4′-morpholinobutyrophenone, phenylbis (2,4,6-trimethylbenzoyl)-phosphine oxide (bis-acyl phosphine oxide), 2-dimethylamino-2-(4-methyl-benzyl)-1-(4-morpholin-4-yl-phenyl)-butan-4-one, ethyl-2,4,6-timethylbenzoylphenylphosphinate (mono-acyl phoshine oxide photoinitiator), 2-hydroxy-2-methylpropiophenone, trimethylbenzophenone, methylbenzophenone; 2-benzyl-2-(dimethylamino)-4′-morpholinobutyrophenone, 1-hydroxycyclohexylphenyl ketone, 2,2-dimethyl-2-hydroxy-acetophenone; 2,2-dimethoxy-2-phenylacetophenone, 2-hyhroxy-1 -{4-[4-(2-hydroxy-2-methyl-propionyl)-benzyl]phenyl}-2-methyl-propan-1-one and the like. Combinations comprising one or more the foregoing may also be used. Suitable commercially available photoinitiators include, but are not limited to LUCIRIN TPO, TPO-L, IRGACURE 907, IRGACURE 819, IRGURRE 2959, IRGACURE 127, IRGACURE 184, IRGACURE 369, IRGACURE 379, BENZOPHENONE, SARCURE SRI 124 (ITX), DAROCUR 1173, 4265 IRGACURE 651, TZT (SarCure SR1 137), and combinations thereof. The photoinitiator composition is used in amounts effective to initiate polymerization in the presence of UV radiation, preferably about 2 to about 20 wt. %, more specifically about 4 to about 15 wt. % based on the total weight of the primer.

The UV/EB curable primers may contain optional additives that are known in the art. These include but are not limited to pigments, fillers, matting agents, slip additives, flow additives, wetting agents, defoamers and stabilizers. Typical additive levels may range from about 0.1 to 20 wt. % based on the total weight of the primer. The amount will depend mostly on the type and function of the additive.

The liquid UV/EB primer composition may be applied using well know application methods. Roll coating methods are preferred. The roll coating methods may include direct gravure, offset gravure, and flexographic application. The roll coating equipment preferably may have from 1 up to about 10 rolls for metering the coating. Rolls surfaces may be engraved or smooth. Roll surfaces may include synthetic rubbers and metals. Doctor blades or other metering devices may be used. Offset gravure or flexographic application is preferred. Primer viscosity may be adjusted by the ratio of polymer to monomer in the composition, the molecular weight of polymer, monomer selection, and the application temperature. Viscosity in the range of about 200 to 2000 cps is preferred for offset gravure or flexographic application. Application near room temperature is preferred because it eliminates the need for temperature controlled coating equipment; however, heated application up to about 80 C could be used as well. The primer may be applied to cover the full surface of the substrate or pattern applied in selected areas. Preferred coating thicknesses for the primer are about 0.2 to 5 microns.

UV/EB curable primers may be useful on any substrate where it is desirable to have HP Indigo printing. The substrate may be in the form of flat sheets or webs. Sheets themselves may be coated with primer or they may be coated in web form and subsequently cut into sheets. Substrate materials include plastic films, papers, metal foils, and fabrics. Substrates may also be composite materials with two more layers. Examples of plastic films include polyesters (PET, APET), polyethylenes (LDPE, LLDPE, HDPE, etc.), polypropylenes (OPP), polyvinyl chloride (PVC), and Nylon. Films may be clear, white, filled, cavitated, etc. Films may have multiple layers including barrier layers, tie layers, heat seal layers, etc. Composite materials may include pressure sensitive label stock with PSAs and release liners, metalized films, film/foil composites, film/paper composites, film/foil/paper composites etc. Fabrics may include woven and non-woven materials and also composites with fabrics and other materials. Primers may be applied and cured off-line before printing or in-line with printing.

Any product that is imaged using HP Indigo print method could use this UV/EB curable primer. One example is tag, label, and ticket printing. This is particularly true if the tag, label, or ticket is subject to harsh environments such as wash cycles, outdoor durability, and product resistance. The primer may also be used for printed packaging including flexible packaging, pouches, and folding cartons. Decorated food service items including cups, plates, and trays may use the primers and could help achieve wash cycle resistance. Commercial printing including brochures, folders, calendars, mailers, displays, and signs may also use the primer. Photo and publication printing using the primer is also anticipated.

Primer compositions containing photoinitiators may be UV cured. Any UV source including UV lamps and UV LEDs may be used. Mercury lamps are well known in the art for curing UV coatings. Mercury lamps may include arc type and microwave powered types. Mercury lamps may be undoped or contain know dopants to shift the spectral output. Lamps may be part of systems that include, reflectors, shutters, air cooling, water cooling, and filters. Typical mercury lamp power input is about 200 to 700 watts per inch of lamp width. Lamp width at least as wide as the web or sheet is desirable. Multiple lamps may be used end-to-end to or series to achieve the desired cure. UV LEDs are well known. LEDs are provided in arrays to provide the desired size and power. LED systems are known with relatively with relatively narrow spectral output centered around 365, 385 or 395 nm. UV LEDs are also known with spectral output in the UVC region. Arrays may combine LEDs with different spectral outputs. The UV source may also have some output in the infrared and visible light regions which generally does not affect the curing process. UV curing may occur in an air atmosphere or the area above the primer layer on the substrate may be blanketed with an inert gas during the UV during.

EB curing will occur without any added photoinitiator. Any source of accelerated electrons may be used. The most common type of accelerators used for EB curing are manufactured by Energy Science and ebeam Technologies. This equipment uses electrically operated filaments within a vacuum chamber. The vacuum may be permanent or may be actively pumped. Electrons are accelerated though a thin metal (typically titanium) foil supported on a water cooled support structure (window). Electrons emerge from the foil into a reaction chamber at atmospheric pressure. It is desirable to purge the reaction chamber with an inert gas such as nitrogen. Preferred electron accelerating voltages are from about 50 to 300 KV. A more preferred accelerating voltage range is about 80 to 125 kV. It is also possible to use EB equipment where the coated substrate is contained in vacuum chamber along with the filament. In this case no foil or window is needed. Low accelerating voltages down to about 10 kV may also be used when curing in a vacuum. Preferred cure dose for the primer is about 2 to 100 kGy. A more preferred cure dose range is from about 15 to 80 kGy. Preferably the beam should be sized or directed to cover the full width of the moving sheet or web.

After HP Indigo printing of the primed web or sheet, the imaged graphics may be protected by additional coating or laminate layers. Coatings may include but are not limited to UV curable coatings, EB curable coatings, water based coatings, and solvent based coating. The coatings may be high gloss, low gloss, or textured. They may be embossed, tinted or otherwise modified to produce desired visual, tactile, or functional effects. Laminate layers may include polypropylene, polyester, polyethylene or other types of films. As examples, the films may be clear, translucent, metalized, glossy, matte or textured. Films may be bonded to the primed and printed layers by heat sealing, adhesive bonding, or extrusion. The combined layers of UV/EB cured primer, dry HP Indigo ink, and coatings or laminates function together to protect the integrity of the digital printed graphics. The protection may include resistance to heat, abrasion, moisture, solvents, cleaners, sunlight, and wear.

### Example 1

A liquid UV curable primer was prepared by combining the following components to form a homogenous mixture:

35.7 wt % Thermoplastic urethane polymer

15.3 wt % Hexane diol diacrylate monomer

17 wt % Tripropylene glycol diacrylate monomer

10 wt % 2-ethyhexyl acrylate monomer

17 wt % Amine acrylate monomer (Ebecryl 7100 brand)

5 wt % Irgacure 127 (Ciba Specialty Chemicals brand of photoinitiator, 2-Hydroxy-1{4-[4-(2-hydroxy-2-methyl-propionyl)-benzyl]-phenyl}-2-methyl-propan-1-one; CAS-No. 474510-57-1)

### Example 2

The liquid primer of Example 1 was applied with a Digicon brand finishing system equipped a flexographic coater (360 line/in, 5 BCM anilox) on a white polyester film based label stock. The system was equipped with a 400 w/in medium pressure mercury arc lamp. The web was run at 15, 30, 45, and 60 m/min. The primer cured to dry tack-free state at all line speeds. After curing, the primer was in the form of a semi-interpenetrating polymer network layer.

### Example 3

The UV cured primer on the substrate from Example 2 was printed with multicolor graphics using an HP Indigo model 6800 digital press. 100% transfer of the graphics was achieved with no voids observed in the printed area. Adhesion of the inks to the cured primer was tested with Scotch 610 tape about 2 hours after printing. At least than 98% of the ink remained on substrate after the tape test. Preferably, at least 90% of the ink should remain, and more preferably at least 95% should remain.

### Example 4

Following the multicolor print test in Example 3 the HP Indigo press was used to apply 100% coverage of yellow ink. The printed yellow layer was clean with no visible ghosting. This test indicates excellent transfer of the inks from the press blanket to the cured primer.

### Example 5

The printed substrate from Example 3 was immersed in room temperature water for more than one week and boiling water for more than 1 hour. The sample was tested for fingernail scratch and tape adhesion immediately upon removing the sample from the room temperature or boiling water. No loss of ink adhesion was observed.

### Comparative Example 6

A conventional commercial water based ink was applied and dried on the same white polyester film label stock used in Example 2. The sample was printed using the same test used in Example 3. The printed sample was subjected to same water soak used in

### Example 5

The ink could be easily scratched or taped off after just 1 hour immersion in room temperature water or 10 minutes in boiling water.

### Example 7

The liquid primer of Example 1 was applied and cured on the metal side of metalized paper board sheets using a sheet-fed roll coating unit equipped with a 400 W/in medium pressure mercury arc lamp. The primer cured to a dry tack-free state.

### Example 8

The UV cured primer on the substrate from Example 7 was printed with multicolor graphics using an HP Indigo sheet-fed press. 100% transfer of the graphics was achieved with no voids observed in the printed area. Adhesion of the inks to the cured primer was tested with Scotch 610 tape about 24 hours after printing. Greater than 98% of the ink remained on substrate after the tape test.

### Example 9

The blanket on the printing press from Example 8 was examined after printing more than 300 sheets. No evidence of residual ink on the blanket was observed. This is in contrast to conventional water based primer that showed evidence of residual ink on the blanket after printing about 20 sheets.

### Example 10

A liquid EB curable primer was prepared by combining the following components to form a homogeneous mixture:

37.6 wt % Thermoplastic urethane polymer

16.1 wt % Hexane diol diacrylate monomer

17.9 wt % Tripropylene glycol diacrylate monomer

10.5 wt % 2-ethyhexyl acrylate monomer

17.9 wt % Amine acrylate monomer (Ebecryl 7100)

### Example 11

The liquid primer of Example 10 was applied with an offset gravure coater to a roll of 2 mil clear polyester film and cured with dose levels of 4 MRads at 150 kV with an oxygen level less than 200 ppm using a BroadBeam EP Series processor. The coating was tack-free and clear immediately upon exiting the EB processor. It was in the form of a semi-interpenetrating polymer network layer.

### Example 12

The EB cured primer from Example 11 was printed with multicolor graphics using an HP Indigo model 6800 press. 100% transfer of the graphics was achieved with no voids observed in the printed area. Adhesion of the inks to the cured primer was tested with tape after 2 hours. Greater than 98% of the ink remained on substrate after the tape test.

1. A digital printing process comprising:
a. applying a liquid radiation curable primer containing 20 to 80% of at least one acrylate functional monomer and 20 to 60% of at least one thermoplastic polyurethane polymer onto a surface of a flat web or sheet substrate;
b. curing the primer by UV or EB irradiation to give a dry, tack-free surface; and
c. using a digital printing press that uses a liquid-toner-based electrographic imaging process with a press blanket to transfer a printed image from the press blanket to the cured-primer coated substrate.

2. The digital printing process of claim 1 where the polyurethane has melting point transition between 50 and 150 degrees C.

3. The digital printing process of claim 1 where the thermoplastic polyurethane is present from 25 to 50%.

4. The digital printing process of claim 1 where UV radiation is used to cure the primer containing from 1 to 15% of at least one free-radical photoinitiator.

5. The digital printing process of claim 1 where the primer is cured by EB irradiation with a dose of 15 to 100 kGy and an accelerating voltage of 80 to 300 kV.

6. The digital printing process of claim 1 where the cured primer thickness is between 0.2 and 5 microns.

7. The process of claim 1 where the primer is applied and cured in a separate step off-line from the liquid toner based electrographic imaging process.

8. The process of claim 1 where the primer is applied and cured in-line immediately before liquid toner based electrographic imaging.

9. The digital printing process of claim 1 where the primer is coated on one surface of the substrate.

10. The digital printing process of claim 1 where the primer is coated on both surfaces of substrate.

11. The digital printing process of claim 1 where the substrate is paper, plastic film, metal foil, fabric, or a composite material with more than one layer of paper, film, metal, or fabric.

12. The digital printing process of claim 1 where sheets of the primed substrate are fed from a stack into the press.

13. The digital printing process of claim 1 where a web of the primed substrate is fed from a roll into the press.

14. The digital printing process of claim 1 where greater than 90 percent of ink transfers from the blanket to the cured primer.

15. A printed web or sheet comprising:
a. a flat web or sheet substrate;
b. a dry, tack-free semi-interpenetrating polymer network layer on a surface of the substrate comprising at least one UV or EB polymerized acrylate monomer and at least one thermoplastic polyurethane polymer; and
c. an image layer of tack-free dried liquid electrographic ink adjacent said semi-interpenetrating polymer network layer.

16. The web or sheet of claim 15 where the polyurethane has melting point transition between 50 and 150 degrees C.

17. The flat web or sheet of claim 15 where the monomer is polymerized by UV radiation in the presence of at least on photoinitiator.

18. The flat web or sheet of claim 15 where the monomer is polymerized by EB radiation with a dose of 15 to 100 kGy and an accelerating voltage of 80 to 300 kV.

19. The flat web or sheet of claim 15 where the thickness of the semi-interpenetrating polymer network layer is between 0.2 and 5 microns.

20. The flat web or sheet of claim 15 where the semi-interpenetrating polymer network layer is on only one side of the substrate.

21. The flat web or sheet of claim 15 where the semi-interpenetrating polymer network layer is on both sides of the substrate.

22. The flat web or sheet of claim 15 where the substrate is paper, plastic film, metal foil, or fabric, or a composite material with more than one layer of paper, film, metal, or fabric.

23. The flat web or sheet of claim 15 which is digitally printed with an ink layer that resists removal by pull off with adhesive tape of 10% or more.

24. The flat web or sheet of claim 23 with an ink layer that resists removal by fingernail scratching or pull off of 5% or more with adhesive tape.

25. The printed web of sheet of claim 15 that is digitally printed and used to produce at least one part of a package.

26. The digital printed web or sheet of claim 25 where the package is a label, flexible package, folding carton, tray, or cup.

27. The printed web or sheet of claim 15 that is digitally printed and used to produce a ticket, brochure, sign, name plate, control panel, display, floor covering, or wall covering material.

28. The printed web or sheet of claim 15 that additionally includes a further protective laminate or coating layer over the electrographic printing.
